(19) United States
(12) Patent Application Publication
(10) Pub. No.: US 2004/0170274 A1
(43) Pub. Date: Sep. 2, 2004

(54) Image forming apparatus and method for inputting encryption key setting

(75) Inventors: Hironobu Machida, Mishima-shi (JP); Toshiyuki Mitsudomi, Numazu-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/787,361

(22) Filed: Feb. 27, 2004

(30) Foreign Application Priority Data
Feb. 28, 2003 (JP) 2003-053145
Feb. 28, 2003 (JP) 2003-053134

(51) Int. Cl. H04L 9/00; H04N 1/44

(52) U.S. Cl. 380/46; 380/277; 380/243

(57) ABSTRACT

An image forming apparatus of the present invention for forming an image based on input image data includes an encryption and decryption unit that encrypts image data using an encryption key prior to the storage of the input image data onto an image storage unit, and decrypts the encrypted image data subsequent to the reading of the encrypted image data from the image storage unit.

### BACKGROUND OF THE INVENTION

1. Field of the Invention

The present invention relates to an image forming apparatus and a method for inputting the setting of an encryption key and, in particular, relates to an image forming apparatus having a storage unit for storing input data.

2. Description of the Related Art

Known image forming apparatuses (such as a copying apparatus, a facsimile device, a printer, a scanner, and an integrated apparatus having these printer and facsimile functions combined, for example) stores input data in a large capacity storage device (HDD) in each apparatus, retrieves data from the storage device, and transfer an image to a sheet of paper based on the data.

Since the storage unit stores the input data, the following security problems arise. For example, information of the data may leak out if a malicious third party steals the storage unit, and retrieves the data from the storage unit using another apparatus. Such a leak is particularly problematic if the data is a confidential document.

The following known devices are used to prevent leakage of confidential documents.

In a first device for preventing leakage of a confidential document, the copying of a particular confidential document is disabled to prevent the confidential document from being leaked.

In another device for preventing leakage of a confidential document, the use of a copying apparatus is limited to a user who is authorized to copy a document. For example, the copying apparatus stores a password provided to the user who is authorized to copy the document. The copying machine performs user authentication based on the password. In this way, the copying apparatus inhibits the access of a person other than the authorized user to image information stored in the copying apparatus.

These techniques for preventing information leakage are disclosed in Japanese Unexamined Patent Application Publication No. 2002-50956 and Japanese Unexamined Patent Application Publication No. 2001-325153.

The technique for setting and inputting the password is disclosed in Japanese Unexamined Patent Application Publication No. 2001-166843 and Japanese Unexamined Patent Application Publication No. 10-63621.

The above-referenced document leakage prevention methods have the following drawbacks.

The first device prevents a company member from leaking a copy of a particular confidential document out of a company by disabling the copying of the particular confidential document. Since the function of the copying apparatus is subject to such a limitation even in in-house use thereof, the copying apparatus cannot be used easily.

The second document leakage prevention device uses the password of the copying apparatus. While the copying apparatus is switched on, a user authentication program remains active, thereby controlling illegal access to the copying apparatus. A malicious third party may remove only a storage device (HDD) from the copying apparatus during power off period, connect the storage device to another apparatus (such as a personal computer), and analyze internal information. The authentication program may fail to operate, and the third party may easily read the internal information.

When information communication is performed using facsimiles, for example, over a network, information is typically encrypted to prevent information leakage on a transmission line.

In a typically available encryption method, a common encryption key is predetermined on both a transmitter side and a receiver side. The transmitter side outputs information encrypted using an encryption key, and the receiver side decrypts a received signal with the encryption key. The encryption key is not transmitted over the transmission line, and even if encrypted information is illegally intercepted, a malicious third party is unable to decrypt the encrypted information.

In the typical encryption method, the encryption key must be entered at an initial setting of the encryption key or the encryption key must be reentered when the already registered encryption key is missing for any reason. In such a case, a correct value of the encryption key must be entered. If an erroneous key value is set, the reading of already stored state may become impossible, or an encryption process may not be performed in a correct manner.

### SUMMARY OF THE INVENTION

Accordingly, it is an object of the present invention to provide an image forming apparatus that prevents stored image data from being leaked.

It is another object of the present invention to provide an image forming apparatus and an image forming method for correctly setting an encryption key for use in encryption when input image data is stored onto a storage device.

An image forming apparatus of the present invention in a first aspect includes an encryption and decryption unit that always encrypts image data using an encryption key prior to the storage of the input image data into an image storage unit, and decrypts the encrypted image data subsequent to the reading of the encrypted image data from the image storage unit.

An image forming apparatus of the present invention in a second aspect includes an input unit for capturing a key value of an encryption key input by a user during the setting of the encryption key, a key value determining unit for determining whether key values input by the user by a predetermined number of times match each other, a non-volatile storage unit for storing the key value input as an encryption key if the key value determining unit determines that the key values match each other, and an encryption and decryption unit for encrypting the image data using an encryption key prior to the storage of the input image data onto an image storage unit, and for decrypting the encrypted image data subsequent to the reading of the encrypted image data from the image storage unit.

The present invention in a third aspect relates to a method for inputting the setting of an encryption key, the encryption key being used to store input image data in an image storage unit, and includes the steps of capturing key values of the encryption key input by a user, determining whether the key values input by the user by a predetermined number of times match each other, and storing, in a non-volatile storage unit, the input key value as the encryption key when it is determined in the key value determining step that the key values match each other.

The image forming apparatus of the present invention includes the encryption and decryption unit that always encrypts the image data using the encryption key prior to the storage of the input image data onto the image storage unit, and decrypts the encrypted image data subsequent to the reading of the encrypted image data from the image storage unit. The image forming apparatus thus prevents the stored image data from being leaked.

The image forming apparatus and the method for inputting the setting of the encryption key of the present invention includes the steps of capturing key values of the encryption key input by a user, determining whether the key values input by the user by a predetermined number of times match each other, and storing, in the non-volatile storage unit, the input key value as the encryption key when it is determined in the key value determining step that the key values match each other, thereby the user can correctly set the encryption key when the encryption key for use in encryption is input.

### BRIEF DESCRIPTION OF THE DRAWINGS

FIG. 1 is a block diagram illustrating an internal structure of an image forming apparatus in accordance with a first preferred embodiment of the present invention.

FIG. 2 is a block diagram illustrating an internal structure of a system CPU in accordance with the first preferred embodiment of the present invention.

FIG. 3 is a block diagram illustrating an internal structure of a page memory controller in accordance with the first preferred embodiment of the present invention.

FIG. 4 is a block diagram illustrating an internal structure of a page memory control unit in accordance with the first preferred embodiment of the present invention.

FIG. 5 illustrates a software configuration of the image forming apparatus in accordance with the first preferred embodiment of the present invention.

FIG. 6 illustrates a memory map of the system CPU and an internal memory content of an ROM in accordance with the first preferred embodiment of the present invention.

FIG. 7 illustrates a process sequence of a boot program in accordance with the first preferred embodiment of the present invention.

FIG. 8 is a flowchart of a control program of the image forming apparatus in accordance with the first preferred embodiment of the present invention.

FIG. 9 is a flowchart of a control program of the image forming apparatus in accordance with a second preferred embodiment of the present invention.

FIG. 10 is a flowchart of a setting input operation for inputting an encryption key in accordance with a third preferred embodiment of the present invention.

FIG. 11 illustrates a display image of an encryption key that is input in accordance with the third preferred embodiment of the present invention.

### DESCRIPTION OF THE PREFERRED EMBODIMENTS

An image forming apparatus and an encryption key setting input method in accordance with the preferred embodiments of the present invention are now described.

First Embodiment

The image processing apparatus in accordance with a first preferred embodiment of the present invention will now be discussed with reference to the drawings. A digital plain paper copier (DPPC) is discussed as an example of the image forming apparatus in accordance with the first preferred embodiment. The present invention is applicable to any other image forming apparatus having a storage unit for storing input image (such as a printer, a facsimile device, a printer/facsimile integrated apparatus, etc.).

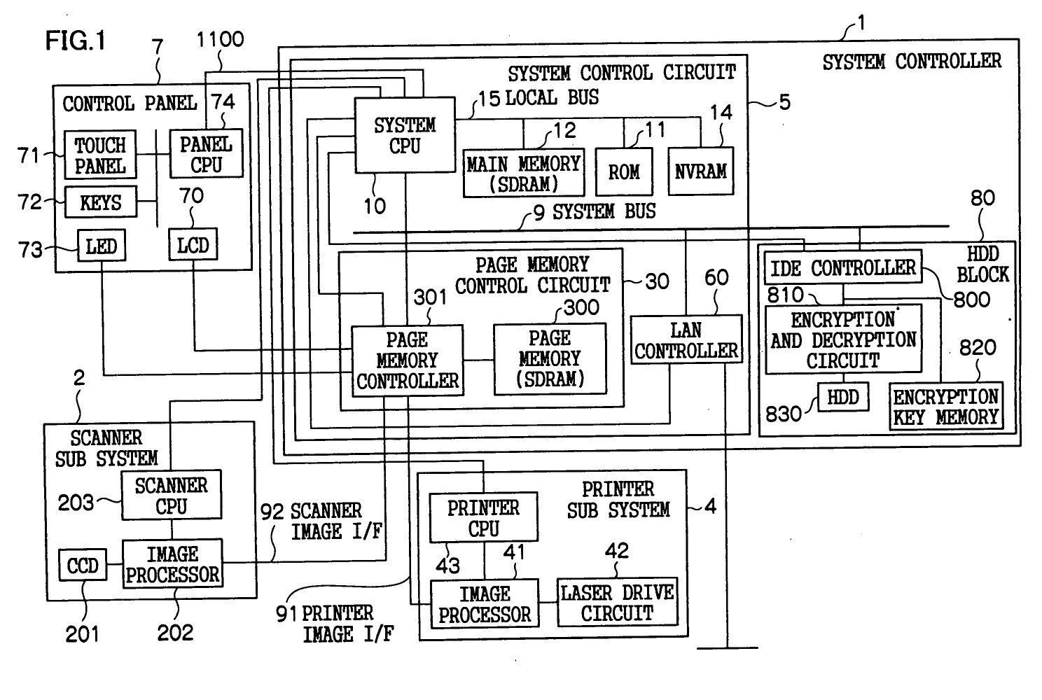

FIG. 1 is a block diagram of the digital plain paper copier in accordance with the first preferred embodiment of the present invention.

The image forming apparatus of the first preferred embodiment of the present invention includes a system controller 1 that generally controls the entire apparatus, a scanner sub system 2 that converts an image of an original document into a digital signal, and outputs image data of the digital signal, a printer sub system 4 for printing an image based on the image data of the digital signal, and a control panel 7 that displays the status of the image forming apparatus, such as paper jamming, and receives a variety of parameters and an operation mode used when a user copies the document.

The scanner sub system 2, the printer sub system 4, and the control panel 7 contain a CPU 203, a CPU 43, and a CPU 74, respectively. The CPU 203, the CPU 43 and the CPU 74 are connected to a system CPU 10 via respective serial interfaces (serial IF) for exchanging control information with the system CPU 10. The CPU 203, the CPU 43 and the CPU 74 respectively control the blocks thereof, and the system CPU 10 generally controls the entire system.

Referring to FIG. 1, the system controller 1 includes two boards, one for a system control circuit 5 and the other for an HDD block 80 for storing data of a plurality of images. In other words, the system control circuit 5 and the HDD block 80 are separate units.

The system control circuit 5 includes the system CPU 10, a main memory 12, an ROM 11, a non-volatile RAM (NVRAM) 14, a page memory control circuit 30, and an LAN controller 60.

A local bus 15 interconnects the system CPU 10, the main memory 12, the ROM 11, and the NVRAM 14. A system bus 9 interconnects the system CPU 10, the HDD block 80, the page memory control circuit 30, and the LAN controller 60.

The internal structure of the system control circuit 5 will now be discussed.

The system CPU 10 controls the entire apparatus. The internal structure of the system CPU 10 will be discussed in detail later.

The ROM 11 stores a control program for generally controlling the image forming apparatus. The system CPU 10 reads the control program from the ROM 11 in accordance with a predetermined rule at power on of the apparatus, and performs a boot process under the control of the control program.

The main memory 12 includes a volatile DRAM. At power on, the system CPU 10 stores the control program read from the ROM 11 onto the main memory 12 in a predetermined area thereof. The control program stored in the main memory 12 runs when the image forming apparatus is on. Further, the main memory 12 stores a random number generated according to a random number generating function when an encryption process, for encrypting an encryption key for use in encryption and decryption of the image data, is performed (the encryption process of the encryption key will be discussed later).

The battery backed-up NVRAM 14 stores setting values for each apparatus. Further, the NVRAM 14 stores the random number, temporarily stored in the main memory 12, in a particular area thereof.

The page memory control circuit 30 temporarily stores image data (digital signal) by page. The page memory control circuit 30 includes a page memory 300 for temporarily storing the image data by page, and a page memory controller 301 for controlling the page memory 300. In response to a request, the page memory control circuit 30 performs a compression process of the image data and a decompression process of the compressed image data as will be discussed later. The internal structure of the page memory controller 301 will be discussed later.

The LAN controller 60 is an interface functioning between a terminal (such as a personal computer) connected to a network (not shown) and the image forming apparatus to exchange image data.

The internal structure of the HDD block 80 is now described.

The HDD block 80 includes a large capacity storage device (hereinafter referred to as hard disk drive: HDD) 830, an encryption and decryption circuit 810, an encryption key memory 820, and an IDE controller 800.

The HDD 830 stores image data of a plurality of images encrypted by the encryption and decryption circuit 810.

The encryption and decryption circuit 810 receives, through the IDE controller 800, the image data that has been compressed by the page memory control circuit 30. The encryption and decryption circuit 810 encrypts the compressed image data using an encryption key, and stores the encrypted image data onto the HDD 830. Also, the encryption and decryption circuit 810 reads the encrypted image data from the HDD 830, decrypts the encrypted image data using the encryption key, and supplies the IDE controller 800 with the decrypted image data (namely, the original compressed image data).

The encryption and decryption method of the encryption and decryption circuit 810 may be any method as long as the method uses an encryption key.

The encryption key memory 820 is a volatile memory for storing the encryption key for use in the encryption and the decryption of the image data. The encryption and decryption circuit 810 reads the encryption key stored in the encryption key memory 820 during the encryption and decryption of the image data.

The IDE controller 800 is an interface functioning between the system bus 9 and each of the HDD 830, the encryption and decryption circuit 810, and the encryption key memory 820. The IDE controller 800 receives compressed image data from the page memory control circuit 30 through the system bus 9 and supplies the encryption and decryption circuit 810 with the received image data. The IDE controller 800 sends the image data, decrypted by the encryption and decryption circuit 810, to the page memory control circuit 30 through the system bus 9.

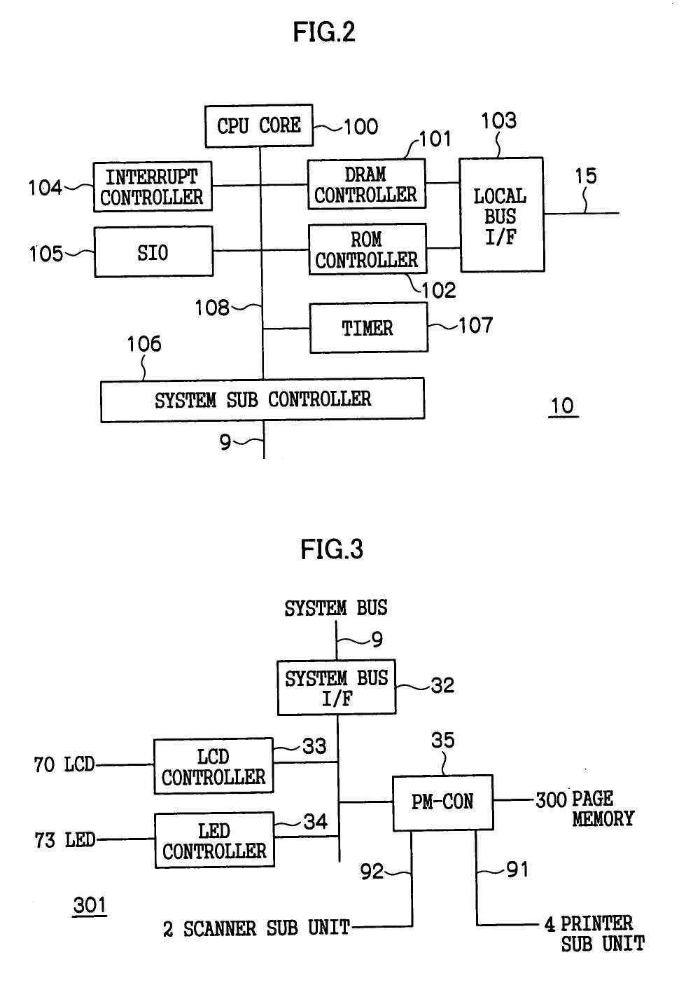

The internal structure of the system CPU 10 of the above-referenced system control circuit 5 is described below. FIG. 2 is a block diagram illustrating the internal structure of the system CPU 10.

As shown in FIG. 2, the system CPU 10 includes a CPU core 100 that executes the control program of the ROM 11, a DRAM controller 101 that controls the main memory 12 (SDRAM) on the local bus 15, an ROM controller 102 that controls the ROM 11 and the NVRAM 14, both present on the local bus 15, a local bus interface 103 functioning between the local bus 15 and each of the DRAM controller 101 and the ROM controller 102, and an interrupt controller 104 that receives interrupts from blocks in the apparatus, and notifies the CPU core 100 of a single interrupt selected according to a predetermined priority order. The system CPU 10 further includes a three-channel serial input and output (I/O) unit 105 that serves as an interface for communications among the scanner CPU 203, the printer CPU 43, the control panel CPU 74, and the CPU core 100, a system bus controller 106 that serves as an interface between each of blocks on the system bus 9 and each of blocks in the system controller 1, a timer 107, and an internal bus 108 that connects the CPU core 100 to each of blocks in the system CPU 10 (including the DRAM controller 101, the ROM controller 102, the interrupt controller 104, the three-channel serial input and output unit 105, the system bus controller 106, and the timer 107).

The internal structure of the page memory controller 301 of the above-referenced page memory control circuit 30 is described below. FIG. 3 illustrates the internal structure of the page memory controller 301.

AS shown in FIG. 3, the page memory controller 301 includes a system bus interface (system bus IF) 32 that interfaces each internal block with the system bus 9, an LCD controller 33, an LED controller 34, and a page memory control unit (PM-CON) 35 that controls the page memory 300 and controls the transfer of image data between the page memory 300, a device on the system bus 9 to be discussed later, the scanner sub system 2 connected thereto through a scanner image interface 92, and the printer sub system 4 connected thereto through a printer image interface 91.

The page memory control unit (PM-CON) 35 arbitrates access requests from the devices accessing the page memory 300 according to a predetermined priority order, and successively accesses the page memory 300 in accordance with the access requests.

The devices accessing the page memory 300 include a scanner image processor 202 that writes the image data onto the page memory 300 through the scanner image interface (scanner image IF) 92, a printer image processor 41 that reads the image data from the page memory 300 through the printer image interface 91, the LCD controller 33, and the IDE controller 800 that stores the image data from the page memory 300 to the HDD 830, and retrieves the image data from the HDD 830 to the page memory 300.

In addition to an area where the image data is temporarily stored, the page memory 300 contains a display data area where display data to be displayed on an LCD 70 is stored. The LCD controller 33 periodically reads the display data from the display data area, and outputs the display data to the LCD 70 in synchronization with a synchronization signal output by the LCD 70 on the control panel 7. The LCD 70 successively displays the display data.

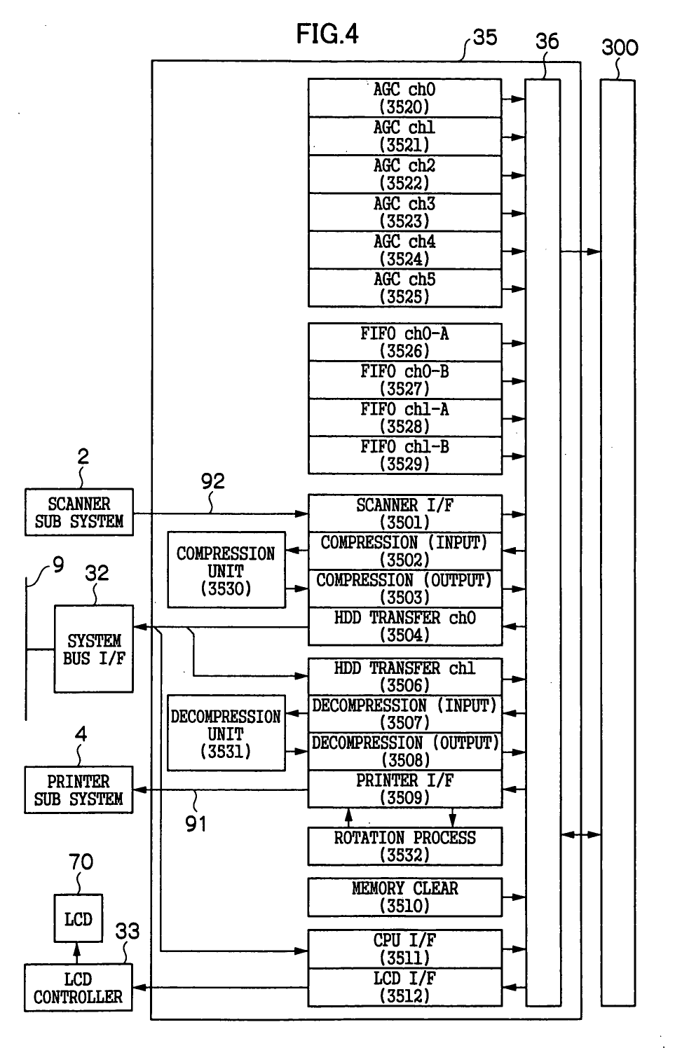

The internal structure of the PM-CON 35 of the page memory 300 will be discussed. FIG. 4 is a block diagram illustrating the internal structure of the PM-CON 35.

The PM-CON 35 includes transfer channels functioning as an interface to transfer data between the page memory 300 and other processing blocks, data processing units (compression unit 3530 and decompression unit 3531), a rotation processing block 3532, an address generator that generates an address of the page memory control circuit 30 for each transfer channel, and a PDRAM controller 36.

The transfer channels include a scanner interface (scanner IF) channel 3501, a printer interface (printer IF) channel 3509, an HDD transfer channel (ch 0) 3504, an HDD transfer channel (ch 1) 3506, a compression (input) channel 3502, a compression (output) channel 3503, a decompression (input) channel 3507, a decompression (output) channel 3508, a memory clear channel 3510, a CPU interface channel 3511, and an LCD interface channel 3512.

The address generator includes an AGC channel (ch 0) 3520, an AGC channel (ch 1) 3521, an AGC channel (ch 2) 3522, an AGC channel (ch 3) 3523, an AGC channel (ch 4) 3524, an AGC channel (ch 5) 3525, an FIFO channel (ch 0-A) 3526, an FIFO (ch 0-B) 3527, an FIFO channel (ch 1-A) 3528, and an FIFO channel (ch 1-B) 3529.

The functions of elements of the PM-CON 35 shown in FIG. 4 will be described later together with the operation of the PM-CON 35.

Returning to FIG. 1, the scanner sub system 2 includes, at least, an original document conveyance unit (not shown) for conveying an original document at a predetermining timing, a CCD 201 for optically reading an image of the original document line by line and converting the image into an electrical signal, a scanner image processor 202, and a scanner CPU 203 for controlling the scanner sub system 2. The scanner image processor 202 converts the electrical signal output from the CCD 201 into a pixel signal (8 bits per pixel, for example), image processes the pixel signal according to an image mode such as one of a character mode, a character and photograph mode, or a photograph mode, performs a tonal gradation process into data of 1 bit/pixel, and outputs the resulting image data to the page memory control circuit 30 through the scanner image interface 92 at a predetermined timing.

The printer sub system 4 includes, at least, a printer image processor 41, a laser drive circuit 42, an image forming unit (not shown), and a printer CPU 43. The printer image processor 41 reads the image data, temporarily stored in the page memory 300, through the printer image interface 91 at a predetermined timing, and processes the read image data according to a designated mode. The laser drive circuit 42 converts the image data, output from the printer image processor 41, into an optical signal. The image forming unit forms an image in response to the optical signal from the laser drive circuit 42 using an electrostatic recording method, and transfers the image to a predetermined sheet. The printer CPU 43 controls the printer sub system 4.

The control panel 7 includes an LCD 70 that displays an apparatus status and information of various parameters, a touch panel 71 arranged on the LCD 70, numeric keys 72, a plurality of LEDs 73, and a panel CPU 74 for generally controlling the control panel 7.

In accordance with the first preferred embodiment of the present invention, the touch panel 71 and the numeric keys 72 are used as input means. Other input means is acceptable as long as a user can use the input means to input data and settings.

The operation of the image forming apparatus of the first preferred embodiment of the present invention will be described with reference to drawings.

A copy sequence of the image forming apparatus is described with reference to FIG. 4.

A scanner interface channel 3501 captures the image data from the scanner sub system 2 (for example, on a per eight pixel basis) in synchronization with the synchronization signal output from the scanner sub system 2. When the data of one data transfer unit (for 32 pixels, for example) is captured from the page memory 300, the scanner interface channel 3501 outputs a transfer request to the PDRAM controller 36.

In synchronization with a data transfer permit signal output from the PDRAM controller 36, the scanner interface channel 3501 outputs, to the PDRAM controller 36, the image data and an address generated by an address generating AGC channel (ch 0) 3520 corresponding to a scanner transfer channel.

The PDRAM controller 36 arbitrates transfer requests of the transfer channels, and determines a transfer permit channel according to an order determined by a round robin scheduling, for example.

In a write process to the page memory 300 through a transfer channel, the PDRAM controller 36 outputs a transfer permit signal to a transfer channel that is permitted to transfer image data, and receives the image data and the address output from the transfer channel in synchronization with the transfer permit signal.

The PDRAM controller 36 converts the received address into an address corresponding to an SDRAM forming the page memory 300, generates a control signal corresponding to the SDRAM, and writes the received image data on an area corresponding to the address.

Address generators (the AGC (ch 0) 3520, the AGC channel (ch 1) 3521, the AGC channel (ch 2) 3522, the AGC channel (ch 3) 3523, and the AGC channel (ch 4) 3524, and the AGC channel (ch 5) 3525) can generate two dimensional addresses corresponding to an original document or a sheet of paper. Each address generator includes a main-scan address counter and a sub-scan address counter.

The main-scan address counter counts up when the corresponding transfer channel completes access after the PDRAM controller 36 permits the corresponding channel to access thereto. When a count of the main-scan address counter reaches a predetermined set value of the original document or the sheet of paper, the sub-scan address counter counts up, and the main-scan address counter is cleared.

When counts of the sub-scan address counter and the main-scan address counter reach predetermined values of the original document of the sheet of paper after repeating the above sequence, the image data of one page is completed. The sub-scan address counter and the main-scan address counter are cleared. The PDRAM controller 36 notifies the system CPU 10 of the accessing of one page using a page memory end interrupt 1201.

The image data read from the scanner sub system 2 is thus stored in the page memory 300.

The compression process of the image data stored in the page memory 300 is now described.

The image data is read from the page memory 300 and is transferred to the compression unit 3530 when the compression (input) channel 3502 issues a request to the PDRAM controller 36 in response to an input request from the compression unit 3530.

The setting of the address generator AGC channel (ch 1) 3521 to use is identical to that of the address generator AGC channel (ch 0) 3520 that has been used to receive the image data from the scanner sub system 2. The image data, transferred from the scanner sub system 2 and stored in the page memory 300, is compressed by the compression unit 3530.

If the image data (hereinafter, also called as compressed data) compressed by the compression unit 3530 is outputtable to the page memory 300 (in other words, if compressed data based on a unit of write (32 bits, for example) to the page memory 300 is present), the compression unit 3530 issues a data output request to a compression (output) channel 3503. The compression (output) channel 3503 writes the compressed data onto the page memory 300 in the same manner as the scanner interface channel 3501.

Address generators (the FIFO channel (ch 1-A) 3528, the FIFO channel (ch 1-B) 3529, the FIFO channel (ch 0-A) 3526, and the FIFO channel (ch 0-B) 3527) are one-dimensional address generating channels. Each address generator includes a register (not shown) having a start address and an end address to be set therewithin, and a loop counter (not shown). The loop counter starts counting up with the start address at each access, loads the start address when the count thereof reaches the end address, and resumes counting up again with the start address.

The FIFO channel (ch 1-A) 3528 is paired with the FIFO channel (ch 1-B) 3529, and the FIFO channel (ch 0 -A) 5526 is paired with the FIFO channel (ch 0-B) 3527, and these perform two channel FIFO counter operations (ch 0 and ch 1).

The FIFO counter operation refers to an operation to adjust the read operation of the page memory 300 not to outpace the write operation of the page memory 300. The FIFO counter operation in the ch 0 is now described. It is assumed that the FIFO channel (ch 0-A) 3526 performs a write operation to the page memory 300 while the FIFO channel (ch 0-B) 3527 performs a read operation. The read access of the FIFO channel (ch 0-B) 3527 is caused to wait on standby when the count of the FIFO channel (ch 0-B) 3527 becomes equal to the count of the FIFO channel (ch 0-A) 3526 so that the reading of the page memory 300 by the FIFO channel (ch 0-B) 3527 does not outpace the writing to the page memory 300 by the FIFO channel (ch 0-A) 3526.

The FIFO channel (ch 0-A) 3526 that performs a write operation continuously monitors a difference between the counts of the two counters. If the difference between the counts equals the difference between the end address and the start address, the FIFO channel (ch 0-A) 3526 will overwrite data before the FIFO channel (ch 0-B) 3527 reads data, and the data will be lost. To prevent this, the request of the FIFO channel (ch 0-A) 3526 is kept to wait on standby.

The FIFO channel (ch 0-B) 3527, functioning as a reading side, reads only the data compressed by the compression unit 3530 from the page memory 300.

The HDD transfer channels 3504 and 3506 function as interfaces for data transfer between the HDD 830 and the page memory 300. The HDD (ch 0) 3504 outputs a transfer request to the PDRAM controller 36 if the compressed data can be received, and captures the compressed data from the page memory 300.

When the HDD transfer channel (ch 0) 3504 receives the compressed data, the IDE controller 800 acquires control of the system bus 9. The compressed data in the HDD transfer channel (ch 0) 3504 is output to the encryption and decryption circuit 810 through the system bus 9.

The encryption and decryption circuit 810 performs an encryption process on the compressed data from the HDD transfer channel (ch 0) 3504 using an encryption key stored in the encryption key memory 820 in advance.

The encryption method is the data encryption standard (DES) that is widely used in data communication. The encryption method is not limited to the DES. Any encryption method may be acceptable as long as the method has decryptability that allows the encrypted data to be decrypted.

The encryption and decryption circuit 810 writes encrypted codes (the encrypted image data) onto the HDD 830.

The compression process of one page is completed by repeating the above process.

A decompression and printing operation of an encrypted code written onto the HDD 830 is now described. The decompression and printing process of the encrypted code is operated in a sequence reverse to the above-referenced compression process.

The encryption and decryption circuit 810 reads the compressed and encrypted image data (encrypted code) from the HDD 830, decrypts the encrypted code into the original compressed data based on the encryption key stored in the encryption key memory 820, and provides the IDE controller 800 with the compressed data.

The IDE controller 800 acquires control of the system bus 9 by outputting a transfer request to the system CPU 10, and transfers the compressed data from the encryption and decryption circuit 810 to the HDD transfer channel (ch 1) 3506 in the PM-CON 35 through the system bus 9 during a transfer permit period.

The system bus controller 106 in the system CPU 10 arbitrates transfer requests from devices on the system bus 9, and permits the IDE controller 800 to transfer the compressed image data in the turn of the IDE controller 800.

The HDD transfer channel 3506 captures the compressed data from the HDD 830 in response to the transfer request from the IDE controller 800 if the compressed data is receivable by the HDD transfer channel (ch 1) 3506. If the data is present in the HDD transfer channel (ch 1) 3506 as a result of the above input process, the HDD transfer channel (ch 1) 3506 outputs a transfer request to the PDRAM controller 36 and writes the compressed data onto the page memory 300.

The decompression (input) channel 3507 outputs a request to the PDRAM controller 36 if it able to capture data thereinto, and reads, from the page memory 300, the compressed data that has been captured from the HDD 830 into the page memory 300, and transfers the compressed data to the decompression unit 3531.

The decompression unit 3531 decompresses the compressed data using a predetermined algorithm.

If the decompressed data is outputtable, the decompression unit 3531 issues a request to the decompression (output) channel 3508 and supplies the decompression (output) channel 3508 with the decompressed data.

The decompression (output) channel 3508 issues a request to the PDRAM controller 36, and writes the received decompressed data onto the page memory 300.

The decompression process of one page is completed by repeating the above-referenced steps.

If no rotation printing command is present, the printer interface channel 3509 reads the image data stored in a printing area on the page memory 300 using the AGC channel (ch 2) 3522. If a rotation printing command is present, a rotation processor 3532 performs a rotation process on the image data. The resulting image data is then sent to the printer sub system 4. The printer sub system 4 outputs the image data in synchronization with a synchronization signal of the printer sub system 4.

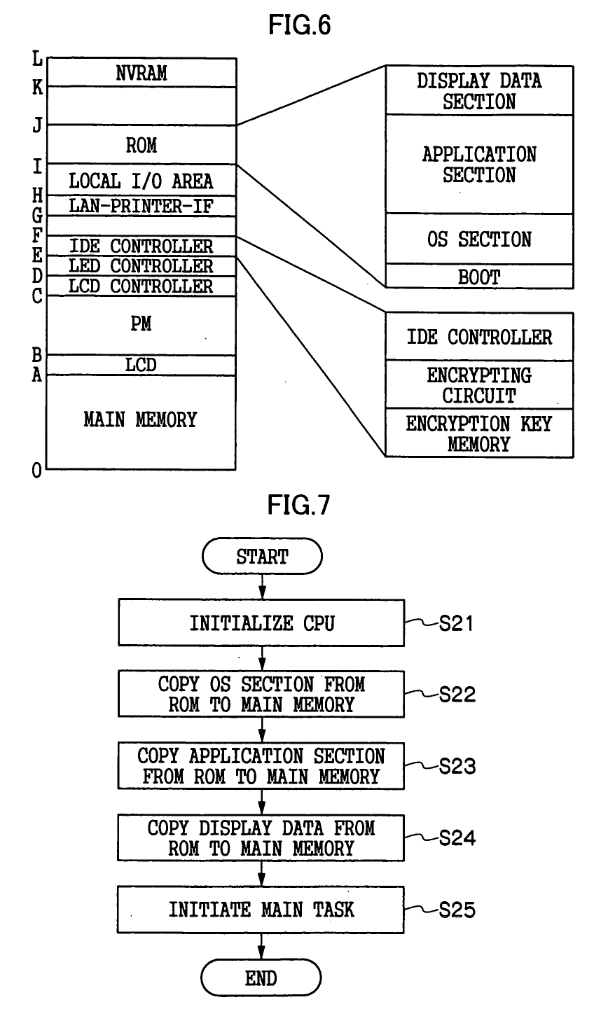

A boot sequence of the image forming apparatus of the first preferred embodiment of the present invention will be described with reference to FIGS. 6 and 7.

FIG. 6 illustrates a memory map of the system CPU 10 and a memory content of the boot ROM 11. FIG. 7 illustrates a process sequence of a boot program.

At power on, the system CPU 10 starts accessing address I of the memory map shown in FIG. 6 storing the boot program.

The system CPU 10 initializes the blocks inside the system CPU 10 shown in FIG. 2 (step S21).

The system CPU 10 successively reads an OS section, an application section, and display data from the ROM 11, and then copies these pieces of information onto a predetermined area of the main memory 12 (steps S22-S24).

The system CPU 10 initiates the main task of the application program copied to the main memory 12, thereby completing the boot process (step S25).

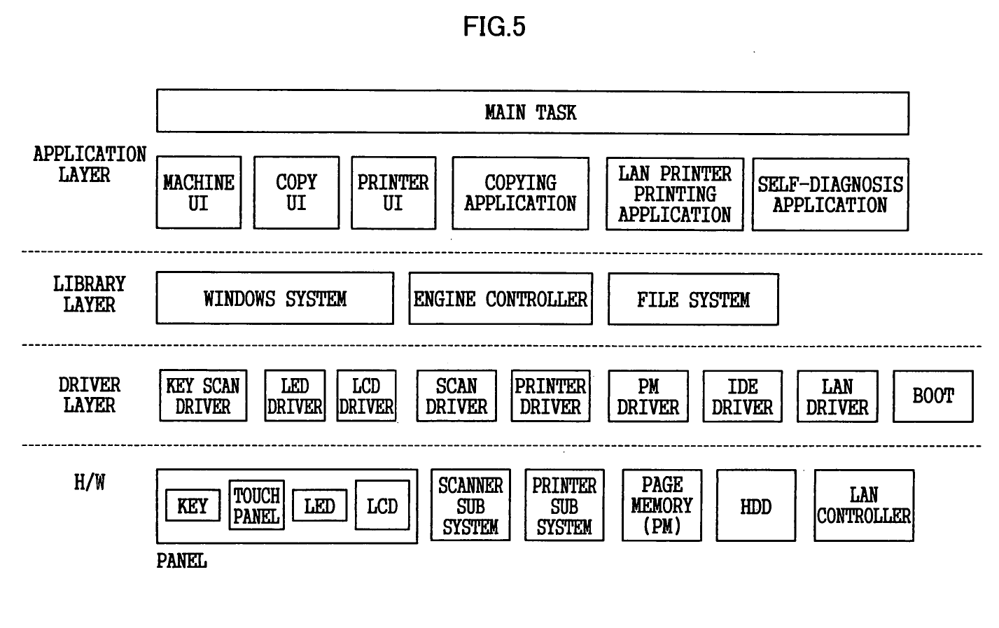

The software configuration of the image forming apparatus of the first preferred embodiment of the present invention is described with reference to FIG. 5. FIG. 5 illustrates the software configuration relating to the operation of the image forming apparatus. A library layer and a driver layer, illustrated in FIG. 5, belong to the OS section of the ROM 11 illustrated in FIG. 6.

The main task initiated subsequent to the boot process initiates an application task.

The application task initiated by the main task includes a copying application for performing a copying process, a printing application for an LAN printer for controlling a printing operation in response to a print request from a terminal (such as a personal computer) connected to a network, a variety of user interfaces (UIs) for controlling interface with the user through the control panel 7, and a self-diagnosis application that operates when the apparatus is started up in an adjustment mode.

One of the UIs is a machine UI that notifies a user of the status of the apparatus. For example, if a jam takes place, the machine UI notifies the user of the jam by displaying the location of the jam on an LCD.

A copying UI and a printer UI provide interfaces in which the user sets parameters during a copying operation and an LAN printer operation, respectively, and notify the user of operational statuses of the copying operation and the LAN printer operation, respectively.

Windows (registered trademark) System controls the LCD to display information from the UIs in a multi-window fashion.

The self-diagnosis application, which is activated in a self-diagnosis mode, sets an adjustment value unique to the apparatus. A typical adjustment value is a shading correction value of a scanner.

In accordance with the first preferred embodiment of the present invention, the encryption key is input, and a random number for the encryption key is generated, and both the encryption key and the random number are encrypted. The encryption key and the random number are then stored in an area of the NVRAM 14. Theses steps may be performed as one function of the self-diagnosis mode.

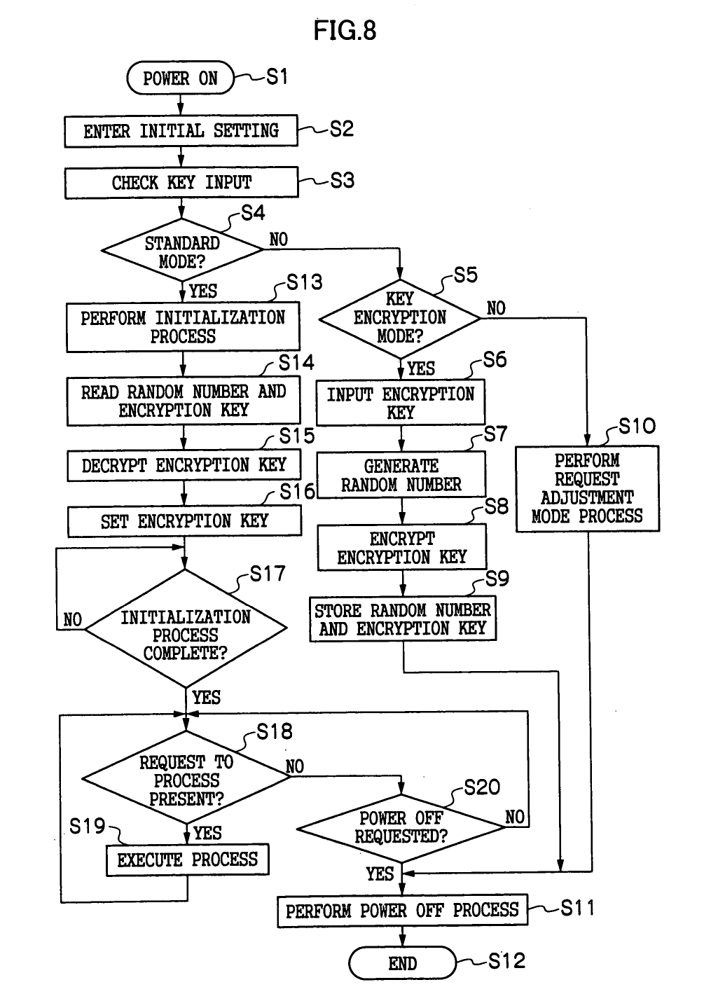

Described next with reference to FIG. 8 are the encryption of the encryption key, and the storing of the encrypted encryption key and the random number onto the NVRAM 14 in the self-diagnosis mode, and the reading of the encryption key from the NVRAM 14, and the storing of the encryption key onto the encryption key memory 820 in a standard operation mode. FIG. 8 illustrates the general flow chart of the control program of the apparatus.

When the apparatus is switched on, the above-described boot process is performed (step S1).

Initial setting is entered into the system controller 1 and the control panel 7 shown in FIG. 1 during the boot process (step S2).

When the control program on the main memory 12 starts operating subsequent to the boot process, it is determined whether a key input is present on the main task (step S3).

If no key is selected at power on, the apparatus operates in the standard operation mode. If any key is selected, the apparatus operates in the self-diagnosis mode (step S4).

A particular key to start the self-diagnosis mode is set, for example, simultaneous press of “1” and “9”. If the user presses the keys 72 of “1” and “9” simultaneously at switch on, the self-diagnosis mode starts (S5).

The LCD 70 displays a screen of the self-diagnosis mode during the self-diagnosis mode. The LCD 70 waits on standby for the user to input a self-diagnosis function number on the self-diagnosis screen.

When a function number other than the one for the encryption process of the encryption key is entered, a self-diagnosis function determined by the input function number is performed (step S10).

If the number for the encryption process of the encryption key is “1”, “2”, and “3”, the apparatus proceeds to the encryption key encryption process if the user enters “1”, “2”, and “3” (step S6).

A message is displayed on the LCD 70 to urge the user to input the encryption key through the keys 72. When the user enters the encryption key, the encryption key code is temporarily stored in the main memory 12. A random number generating function prepared in software generates a random number, and the random number is also temporarily stored in the main memory 12 (step S7).

The encryption key code is encrypted using the random number as an encryption key (step S8).

The encryption method to be used is the above-mentioned DES, and is carried out in software by the system CPU 10.

The encrypted encryption key and the random number are stored in a particular area predetermined in the non-volatile NVRAM 14 (step S9).

The LCD 70 notifies the user of the completion of the storage of the encryption key code, and urges the user to switch off power (step S11).

When the user switches off power in response to the instruction, the process ends (step S12).

If the user selects no keys 72 at power on, the apparatus operates in the standard operation mode subsequent to the boot process (step S4).

During the standard operation mode, the system CPU 10 issues a command for initialization to the scanner sub system 2 and the printer sub system 4 (step S13).

The system CPU 10 reads the encrypted encryption key and the random key, from the NVRAM 14 (step S14), and decrypts the encryption key using as the random number as a key (step S15).

The system CPU 10 stores the decrypted encryption key onto the volatile encryption key memory 820 through the system bus 9 (step S16).

The system CPU 10 waits on standby for the completion of the initialization of the scanner sub system 2 and the printer sub system 4. Upon receiving the notification of completion, the system CPU 10 checks if the remaining blocks are in a ready state. If the remaining blocks are ready, the system CPU 10 displays a “ready” state indication on the LCD 70. The system CPU 10 then waits for a request on standby (steps S17 and S18).

If the user selects a copy start key among the numeric keys 72, the system CPU 10 determines that a copy request has been issued and performs the above-mentioned copying sequence. When the copying sequence ends, the system CPU 10 waits on standby (step S19).

If power is switched off during the waiting for a request (step S20), a power off process is performed, and the apparatus is switched off (S11).

The panel CPU 74 periodically checks the touch panel 71 and the numeric keys 72 to detect a key input from the control panel 7. If any key is selected at the moment of check, the panel CPU 74 sends a code corresponding to the selected key to the system CPU 10 through a serial interface 1100.

The serial input and output unit (SI0) 105 in the system CPU 10 receives the code data, and notifies the CPU core 100 of the presence of the received code through the interrupt controller 104.

The CPU core 100 recognizes the selected key by reading the received data from the serial input and output unit 105.

With the encryption and decryption circuit 810 incorporated, the image forming apparatus of the first preferred embodiment of the present invention encrypts the image data according to the encryption key and stores the encrypted in the HDD 830. Even if another individual is in possession of the HDD 830, the encrypted data must still be decrypted. The data is thus prevented from being leaked.

The image forming apparatus of the first preferred embodiment incorporates the non-volatile NVRAM 14 on a circuit board different from the HDD and the peripheral control circuit thereof. The NVRAM 14 stores the encryption key used in the encryption of the data. Even if another person is in possession of the HDD and the peripheral control circuit board thereof, the encryption key itself is prevented from being stolen. Decrypting the encrypted data is thus difficult.

In the image forming apparatus of the first preferred embodiment, the encryption key code stored in the non-volatile NVRAM 14 is encrypted using the random number code that is generated at the shipment of the apparatus and stored in another area in the NVRAM 14. Even if another person is in possession of the HDD together with the NVRAM 14, the decrypting of the encryption key from the data stored in the NVRAM 14 is still difficult.

Second Preferred Embodiment

The difference of a second preferred embodiment of the present invention from the first preferred embodiment is that the encryption key for use in the encryption of the image data is also subjected to a predetermined compression process, and that the compressed encryption key is stored in the NVRAM 14.

The system control circuit 5 will be described in detail, and the discussion of the functions of the remaining blocks is omitted. The second preferred embodiment is described referring to elements and the reference numerals in FIG. 1.

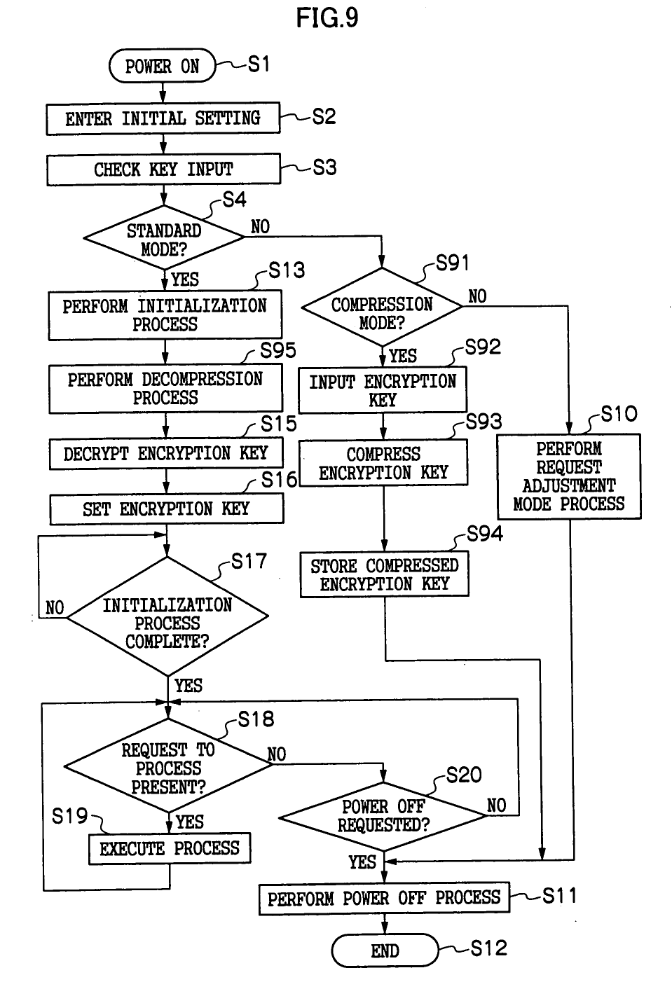

FIG. 9 is a flowchart of the operation of the second preferred embodiment.

As shown in FIG. 9, steps from a power on step (step S1) to a determination step (S4) for determining whether to operate in the standard operation mode and the self-diagnosis mode based on the key input in the second preferred embodiment remain identical to the same steps (from the step S1 through the step S4) in the first preferred embodiment. In accordance with the second preferred embodiment, the compression process for compressing the encryption key is performed as one function of the self-diagnosis mode.

When the user enters a function number for the compression process of the encryption key with the apparatus set to the self-diagnosis mode, the apparatus starts the compression process (step S91).

The user enters the encryption key through the numeric keys 72, and the input encryption key is temporarily stored (step S92).

The encryption key is then sent to the compression unit 3530 in the PM-CON 35. The compression unit 3530 compresses the encryption key (S93).

The compression process of the encryption key is performed in the following manner.

Upon receiving the encryption key, the compression unit 3530 adjusts the number of bits of the encryption key to meet a unit of bits of an area that enables the compression process. For example, if the number of bits is smaller than the unit of bits of the area that enables the compression process, the encryption key is arranged at the front end of the compression process area with “all zeroes (or all ones)” inserted to the remaining region of the area. The encryption key is thus adjusted to be in alignment with the unit of the compression process area.

When the encryption key is adjusted to be in alignment with the unit of the compression process area, the compression unit 3530 compresses the encryption key. The compression process method in accordance with the second preferred embodiment of the present invention may be the method used in the compression process of the image data. Any method may be used as long as the compression process and the decompression process are reciprocal to each other.

The encryption key compressed by the compression unit 3530 is stored in a predetermined area in the NVRAM 14 (S94).

The operation thereafter is identical to that of the first preferred embodiment, and the discussion thereof is omitted here.

If the determination in step S4 based on the key input at power on indicates the standard operation mode, the compressed encryption key stored in the NVRAM 14 is decompressed as follows.

The apparatus proceeds to the standard operation mode. A command to initialize the scanner sub system 2 and the printer sub system 4 is issued (step S13).

In response to a command from the system CPU 10, the compressed encryption key is supplied to the page memory controller 301 from the NVRAM 14. The decompression unit 3531 decompresses the compressed encryption key (step S95).

The compressed encryption key is decompressed using a method identical to the one used to decompress the image data in accordance with the first preferred embodiment. If the decompression (input) channel 3507 is able to receive data, the decompression (input) channel 3507 issues a request to the PDRAM controller 36, thereby supplying the data of the compressed encryption key from the page memory 300 to the decompression unit 3531.

The operation of the second preferred embodiment thereafter is identical to that of the first preferred embodiment, and the discussion thereof is omitted here.

The second preferred embodiment of the present invention provides the same advantages as the first preferred embodiment.

In accordance with the second preferred embodiment of the present invention, the compressed encryption key is stored in the NVRAM 14. The stored compressed encryption key must be decompressed, even if the NVRAM 14 is stolen and read. The decryption of the encryption key is thus difficult, thereby preventing the data from being leaked.

Third Preferred Embodiment

In a third preferred embodiment, input image data, before being stored onto the HDD, is encrypted using an encryption key unique to each apparatus. At initial setting, or when the encryption key unique to the apparatus is missing, the user stores the encryption key unique to the apparatus in the NVRAM 14.

In the description of the third preferred embodiment, the system controller 1 and the control panel 7 will be described in detail, and the description of the functions of the remaining blocks is omitted here. The elements and the reference numerals in FIG. 1 are also used in the discussion that follows.

The structure of the HDD block 80 in accordance with the third preferred embodiment of the present invention will be described with reference to FIG. 1.

The HDD 830 stores image data of a plurality of pieces of images encrypted by the encryption and decryption circuit 810. Several cases are contemplated in the storage of encrypted image data in the HDD 830 in the image forming apparatus of the third preferred embodiment. For example, a plurality of prints, both-side prints or 2-in-1 prints may be produced based on the encrypted image data stored in the HDD 830. In the 2-in-1 print, images of two pages are printed on a single page of a sheet in juxtaposition.

The encryption and decryption circuit 810 may use any type of method as long as the method converts original data into data having a hard-to-decrypt format using the encryption key unique to each apparatus, and then restores the original data from the converted data using the encryption key. The encryption key unique to the apparatus is individually set in each apparatus when the apparatus is manufactured.

The encryption key memory 820 is a volatile memory that stores the encryption key in use for the encryption and decryption of the image data. When the encryption and decryption circuit 810 encrypts the image data and decrypts the encrypted image data, the encryption key memory 820 receives the encryption key from the NVRAM 14, continuously stores the encryption key during power on period, and discards the encryption key at the moment of power off.

The internal structure of the system control circuit 5 is now described with reference to FIG. 1.

The NVRAM 14 is a battery backed-up non-volatile storage unit storing setting values of each apparatus. The NVRAM 14 stores the encryption key for use in the encryption of the image data, and supplies the encryption key memory 820 with the encryption key during the encryption process and the decryption process of the encryption and decryption circuit 810 subsequent to power on.

The ROM 11 stores the control program for controlling the entire apparatus. The system CPU 10 reads the control program from the ROM 11 in accordance with a predetermined rule at power on of the apparatus, and performs a boot program under the control of the control program. The ROM 11 also stores the program relating to the inputting of the encryption key in accordance with the third preferred embodiment of the present invention.

The main memory 12 includes a volatile DRAM. At power on, the system CPU 10 stores the control program read from the ROM 11 onto the main memory 12 in a predetermined area. The control program stored on the main memory 12 runs with power on. Further, the main memory 12 temporarily stores a key value relating to an encryption key setting input by the user.

In accordance with the third preferred embodiment, the user enters the key value relating to the encryption key setting by a plurality of times (twice, for example). If the key values are correct, that key value is treated as an encryption key.

The control panel 7 of the third preferred embodiment of the present invention will now be described with reference to FIG. 1.

The control panel 7 includes an LCD 70 that displays an apparatus status and information of various parameters, a touch panel 71 arranged on the LCD 70, numeric keys 72, a plurality of LEDs 73, and a panel CPU 74 for generally controlling the control panel 7.

In accordance with the third preferred embodiment of the present invention, the touch panel 71 and the numeric keys 72 are used as input means. Other input means is acceptable as long as a user can use the input means to input data and settings.

The input means, such as the touch panel 71 and the numeric keys 72, receives the key value of the encryption key input by the user at the initial setting or in case the encryption key is missing from the NVRAM 14. The determination of whether the encryption key is correct is performed as below. The user enters the key value of the encryption key at least twice (twice in the third preferred embodiment), and a determination is made whether a first time key value is identical to a second time key value. If the first time key value is identical to the second time key value, that key value is treated as an encryption key. If the first time key value is not identical to the second time key value, an error is triggered rather than setting the encryption key based on that key value.

The LCD 70 is a display for displaying the key value of the encryption key entered by the user. The LCD 70 displays the key value on four digits by four digits basis. When the key value of four digits is entered, the key value of those four digits is changed to “asterisk signs”. More generally, the key value of M digits (M is an integer equal to or greater than 1) is divided on N (N is an integer equal to or greater than 1) digits by N digits basis (M being greater than N). When the key value of given N digits is input, the key value of those N digits is changed to asterisk signs “*” This change is intended to prevent any third party from stealthy glancing at the key value displayed on the LCD 70.

In the third preferred embodiment, the key value is changed to asterisk signs. The present invention is not limited to the asterisk sign. Any symbols, such as a dash (-), a sharp sign (#), or space (blank), may be used as long as the symbol has no particular meaning.

The operation of the image forming apparatus of the third preferred embodiment for inputting the encryption key for use in the encryption of the image data is discussed with reference to the drawings.

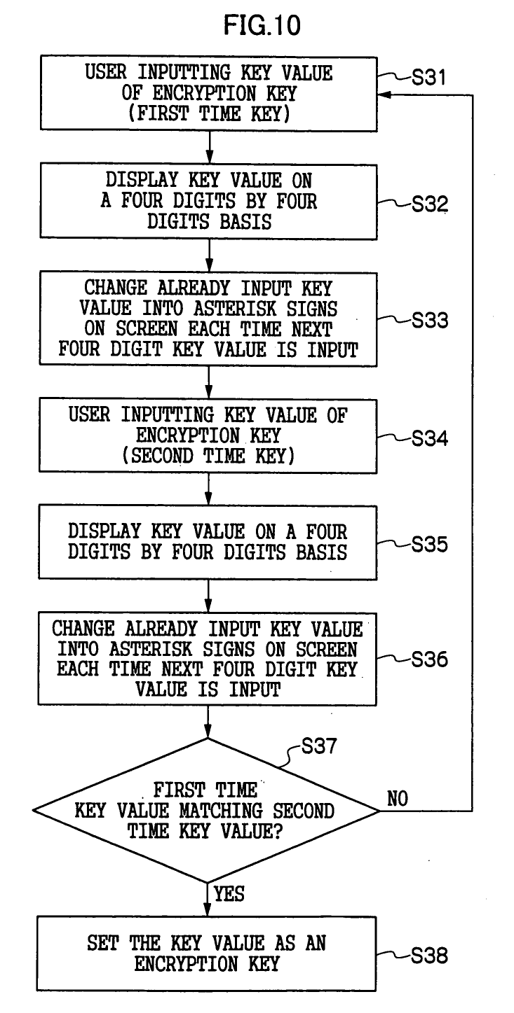

FIG. 10 is a flowchart illustrating the setting encryption key in accordance with the third preferred embodiment.

A message is displayed on the LCD 70 to urge the user to enter the encryption key unique to each apparatus during initial setting or when the encryption key is missing for any reason. Alternatively, without displaying any message requesting the user on the LCD 70 to enter the encryption key, the user may start the encryption key setting.

The user enters the key value of the encryption key through the touch panel 71 or the numeric keys 72 (step S31).

In the third preferred embodiment, the key value of the encryption key is displayed in 16 digits in a hexadecimal format (64 bits). The key value of the encryption key may include an error detection sign of a predetermined number of bits.

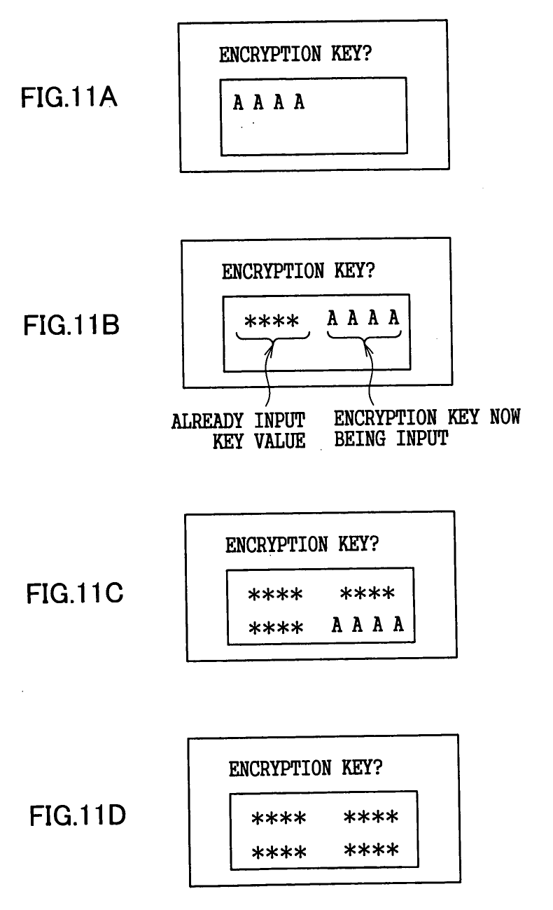

The LCD 70 displays the key value of the encryption key input by the user (step S32). FIG. 11 shows a display of the key value of the input encryption key.

Referring to FIG. 11A, the key value input by the user is displayed on four digits by four digits. When the key value of second four digits is entered by the user as shown in FIG. 11B, in succession to the key value of first four digits, the key value of already input first four digits is converted to asterisk signs. Alternatively, the key value may be changed to asterisk signs when any four digits are entered.

When the key value of all 16 digits is entered as shown in FIG. 11C by repeating this process, the key value of all 16 digits appears in asterisk signs as shown in FIG. 11D (step S33).

The apparatus requests the user to re-enter the key value input in steps S31-S33. Like in the first time, the key value is shown on four digits by four digits. When the key values of second four digits are entered subsequent to the key values of first four digits, the key values of the first four digits are changed to asterisk signs (steps S34-S36).

It is determined whether the key value entered for the first time is identical to the key value entered for the second time (step S37).

When the first time key value and the second time key value are identical, that key value is set in the NVRAM 14 (step S38).

If the first time key value is different from the second time key value, no key value is set because of an error in the input key values. The user may be requested to enter the key value of the encryption key again.

The user thus enters the encryption key at the initial setting or when the encryption key is missing.

In accordance with the third preferred embodiment, the encryption key for use in the encryption of the image data is stored in the NVRAM 14 on a board different from the HDD 830 storing the encrypted image data. Even if another person is in possession of the HDD 830, the stored data on the HDD 830 is prevented from being decrypted if the NVRAM 14 is safe.

In accordance with the third preferred embodiment, the user may enter the encryption key for several times. Security is enhanced by determining whether the encryption keys match each other.

In accordance with the third preferred embodiment, the encryption key entered by the user is changed to asterisk signs per predetermined number of digits basis so that no third party may steal a glance at the encryption key.

Alternate Embodiments

In accordance with the first preferred embodiment, the random number generated and the encrypted encryption key are stored in the NVRAM 14. It is important that the encryption key stored in the NVRAM 14 is in the form difficult to decrypt even if a third party is in possession of the NVRAM 14.

For example, the encryption key related to the encryption of the image data is further encrypted by a second encryption key. The resulting encryption key is stored in NVRAM 14. The second encryption key used to encrypt the encryption key may be stored in another non-volatile memory.

In accordance with the first through fourth preferred embodiments, the present invention is applied to the digital copying apparatus. The present invention is applicable to an image forming apparatus, having a storage device (HDD) storing encrypted data, such as a printer, a facsimile device, a printer/facsimile integrated apparatus, etc.

The present invention may be applied to a printer, for example. The printer receives image data from a user terminal, such as a personal computer, and prints an image of the image data on a plurality of sheets of paper. The image data is encrypted before being stored in the HDD.

The present invention may be applied to a facsimile device, for example. One of the first through third preferred embodiments may be used when receiving facsimile information or transmitting facsimile information from storage.

The present invention may be applied to an image forming apparatus such as a printer/facsimile integrated apparatus. The integrated apparatus is used with encryption keys respectively set for the functions of printer and facsimile.

In accordance with the third preferred embodiment, the key value input by the user is shown on a four digits by four digits basis. The key value of four digits already input is converted to asterisk signs on screen if the key value of next four digits is entered. The present invention is not limited to this method. Any arrangement is acceptable as long as the arrangement prevents a third party from stealing a glance at the key value. For example, each digit may be changed to an asterisk sign each time the value of the digit is entered, or eight digits may be changed to asterisk signs each time the inputting of the value of the eight digits is completed.

In accordance with the third embodiment, a determination of whether the first time key matches the second time key is performed subsequent to the inputting of the second time key. The present invention is not limited to this method. The match determination may be performed each time the inputting of the key value of each digit or four digits is completed.

In accordance with the third preferred embodiment, a newly input key is unique to each apparatus when the encryption key is input at the initial setting or when the encryption key is missing. The newly input key may be determined by the user himself or herself.

In accordance with the third preferred embodiment, the LCD 70 displays the key value of the encryption key input previously.

In accordance with the third preferred embodiment, the inputting and displaying of the key value are performed in a hexadecimal format. Alternatively, the inputting and displaying of the key value may be performed in a decimal format.

What is claimed is:

1. An image forming apparatus for forming an image based on input image data, the image forming apparatus comprising encryption and decryption means that encrypts image data using an encryption key prior to the storage of the input image data onto image storage means, and decrypts the encrypted image data subsequent to the reading of the encrypted image data from the image storage means.

2. The image forming apparatus according to claim 1, further comprising non-volatile storage means for storing the encryption key,
wherein the encryption and decryption means temporarily stores the encryption key, sent from the non-volatile storage means, in a temporary storage unit therewithin when the image data is stored onto the image storage means and/or when the encrypted image data is read from the image storage means.

3. The image forming apparatus according to claim 2, wherein the encryption and decryption means and the non-volatile storage means are arranged in separate units.

4. The image forming apparatus according to claim 1, further comprising encryption key generating means for generating a random number and producing the encryption key that contains at least a portion of the generated random number.

5. The image forming apparatus according to claim 2, further comprising encryption key generating means for generating a random number and producing the encryption key that contains at least a portion of the generated random number.

6. The image forming apparatus according to claim 2, further comprising encryption key compression and decompression means for compressing and/or decompressing the encryption key using a predetermined compression and decompression method,
wherein the compressed encryption key is stored onto the non-volatile storage means and when the encryption key is used, the compressed encryption key is read from the non-volatile storage means.

7. The image forming apparatus according to claim 4, further comprising encryption key compression and decompression means for compressing and/or decompressing the encryption key using a predetermined compression and decompression method,
wherein the compressed encryption key is stored onto the non-volatile storage means and when the encryption key is used, the compressed encryption key is read from the non-volatile storage means.

8. The image forming apparatus according to claim 5, further comprising encryption key compression and decompression means for compressing and/or decompressing the encryption key using a predetermined compression and decompression method,
wherein the compressed encryption key is stored onto the non-volatile storage means and when the encryption key is used, the compressed encryption key is read from the non-volatile storage means.

9. The image forming apparatus according to claim 6, wherein the encryption key compression and decompression means applies an image compression and decompression unit for compressing and/or decompressing the image data.

10. The image forming apparatus according to claim 7, wherein the encryption key compression and decompression means applies an image compression and decompression unit for compressing and/or decompressing the image data.

11. The image forming apparatus according to claim 8, wherein the encryption key compression and decompression means applies an image compression and decompression unit for compressing and/or decompressing the image data.

12. An image forming apparatus for forming an image based on input image data, the image forming apparatus comprising:
input means for capturing a key value of an encryption key input by a user during the setting of the encryption key;
key value determining means for determining whether key values input by the user by a predetermined number of times match each other;
non-volatile storage means for storing the key value input as an encryption key if the key value determining means determines that the key values match each other; and
encryption and decryption means for encrypting the image data using an encryption key prior to the storage of the input image data onto image storage means, and for decrypting the encrypted image data subsequent to the reading of the encrypted image data from the image storage means.

13. The image forming apparatus according to claim 12, further comprising display means for displaying the key value captured by the input means, and converting an input key value into a form having no specific meaning.

14. The image forming apparatus according to claim 13, wherein the display means divides the key value of M digits on an N digits by N digits basis (M being greater than N), and converts a part of the key value of the N digits into a form having no specific meaning as soon as the inputting of the key value of the part of the N digits is completed.

15. The image forming apparatus according to claim 12, wherein the inputting and displaying of the key value is performed in one of a decimal format and a hexadecimal format.

16. The image forming apparatus according to claim 13, wherein the inputting and displaying of the key value is performed in one of a decimal format and a hexadecimal format.

17. The image forming apparatus according to claim 14, wherein the inputting and displaying of the key value is performed in one of a decimal format and a hexadecimal format.

18. A method for inputting the setting of an0 encryption key for use in the encryption of image data, the encryption key being used to store input image data in image storage means, the method comprising the steps of:
capturing key values of the encryption key input by a user;
determining whether the key values input by the user by a predetermined number of times match each other; and
storing, in non-volatile storage means, the input key value as the encryption key when the key values match each other in the key value determining step.

19. The method according to claim 18, further comprising a step for displaying the key value captured in the capturing step, and for converting an already input key value into a form having no specific meaning.
